(19) United States
(12) Patent Application Publication
(10) Pub. No.: US 2013/0124248 A1
(43) Pub. Date: May 16, 2013

(54) Active Device for Providing Real Time Parolee Information

(71) Applicants: Quyen Kiet, Las Vegas, NV (US); Barry Goldstein, Las Vegas, NV (US)

(72) Inventors: Quyen Kiet, Las Vegas, NV (US); Barry Goldstein, Las Vegas, NV (US)

(73) Assignee: GOLD POST TECHNOLOGIES, INC., Las Vegas, NV (US)

(21) Appl. No.: 13/590,883

(22) Filed: Aug. 21, 2012

Related U.S. Application Data
(60) Provisional application No. 61/559,396, filed on Nov. 14, 2011.

(51) Int. Cl. G06Q 10/06

(52) U.S. Cl. 705/7.19

(57) ABSTRACT

An apparatus and method that enable a case officer to manage visits to probationers according to their risk level priority. The apparatus receives probationer information from a remote supervision server and displays the information by their risk levels. The case officer can drag and drop the name of probationers on an appointment calendar which will calculate an appointment schedule according to the location of each visit, the travel time between the visits, the default first visit time, and default last visit time. After the appointment schedule is calculated, the map will display the optimized route. The case officer can manually change the order of the visits and the apparatus will automatically recalculate the appointment schedule and the route. The invention can further process all the data used to calculate risk of recidivism to predict criminal activity in a given area using location specific information and data collected for probationer management.

### RELATED APPLICATION

This application is a non-provisional of U.S. Provisional Application for System And Method For Real Time Criminal Activity Prediction And Risk Assessment, U.S. Provisional patent application No. 61/559,396, filed on Nov. 14, 2011, the specification of which is included in its entirety by this reference.

### BACKGROUND OF THE INVENTION

1. Field of the Invention

The present invention generally relates to a computing appliance, and more specifically, relates to a computing appliance that receives probationer (and/or parolee) information from a remote server and generates a visiting schedule for a case officer based on the risk assessment of the probationer/probationer.

2. Description of the Related Art

Each local government spends considerable money tracking and monitoring post-release convicts (which include probationers and parolees) living within the county after they are released from incarceration, or as part of a court ordered sentence. After an offender is approved for post-release supervision, he is subject to monitoring under the terms of parole or probation, or some form of post-release supervision collectively referred to herein as “probation” with a supervised offender referred to collectively as a “probationer”. Usually, the probationer must register with a local authority and he is assigned a case officer with whom he must check in periodically. A case officer is usually charged with one hundred or more probationers and he must make time to monitor and track each probationer. The probationer must physically report to the case officer personally on a periodic basis.

In addition to the probationer's in-person report to a case officer, the case officer also pays unscheduled visits to the probationers. It is important for a case officer to see in person the living condition and the work condition for each probationer. Case officers generally schedule visits with probationers in an order that does not take the risk of recidivism into consideration. The visits often fail to address the probationers at highest risk for recidivism because the information the case officer has about the probationers may not be updated and consequently the productivity of a case officer is hampered.

Therefore, there is a need for an apparatus that provides the latest probationer information of risk and need as they relate to the likelihood of recidivism, and it is this apparatus and system that the present invention is primarily directed to.

### SUMMARY OF THE INVENTION

In one embodiment, there is provided an apparatus, for assisting a probation officer to track and plan visits to probationers according to the risk of recidivism of each probationer. The apparatus comprises a data communication controller for receiving probationer information from a remote server, a display for displaying information, a central processing unit for controlling operation of the apparatus, and a storage unit for storing the probationer information received from the remote server and also for storing applications. The applications, when executed by the central processing unit, cause the apparatus to display a list of probationers according to a recidivism risk assigned to each probationer on the display, to receive inputs from the probation officer, to populate an appointment calendar according to the inputs received, to determine a location for each appointment on the appointment calendar, and to calculate a path for visiting appointments on the appointment calendar.

In another embodiment, there is provided a method for assisting a probation officer to schedule visits to probationers. The method comprises the steps of receiving probationer information for a plurality of probationers from a remote server, the probationer information for each probationer including a recidivism risk, displaying a list of probationers according to the recidivism risk assigned to each probationer on a display device, receiving inputs from the probation officer, populating an appointment calendar according to the inputs received, determining a location for each appointment on the appointment calendar, and calculating a path for visiting appointments on the appointment calendar.

In yet another embodiment there is provided a tangible non-transitory computer-readable medium comprising instructions that, when executed by a processor, cause the processor to perform acts, for assisting a probation officer to schedule visits to probationers, comprise receiving probationer information for a plurality of probationers from a remote server, the probationer information for each probationer including a recidivism risk, displaying a list of probationers according to the recidivism risk assigned to each probationer on a display device, receiving inputs from the probation officer, populating an appointment calendar according to the inputs received, determining a location for each appointment on the appointment calendar, and calculating a path for visiting appointments on the appointment calendar.

The present system and methods are therefore advantageous as they provide meaningful real time probationer information to case officers and criminal activity predictions to law enforcement agencies. Other advantages and features of the present invention will become apparent after review of the hereinafter set forth Brief Description of the Drawings, Detailed Description of the Invention, and the Claims.

### BRIEF DESCRIPTION OF THE DRAWINGS

Features and advantages of embodiments of the invention will become apparent as the following detailed description proceeds, and upon reference to the drawings, where like numerals depict like elements, and in which:

FIG. 1 depicts the relationship between a remote supervising system and other components;

FIG. 2 depicts a system architecture of the remote supervision system according to the invention;

FIG. 3 illustrates a display of an apparatus according to the invention;

FIG. 4 illustrates another display of an apparatus according to the invention;

FIG. 5 illustrates a process for planning visits using the real time probationer information according to the invention; and

FIG. 6 illustrates architecture of an active device according to the invention.

### DETAIL DESCRIPTION OF THE INVENTION

In the following description, the term “exemplary” is meant only as an example, and does not indicate any preference for the embodiment or elements described. Further, like numerals refer to like elements throughout the several views, and the articles “a” and “the” includes plural references, unless otherwise specified in the description. The terms “parole officer”, “probation officer” and “case officer” are used interchangeably, so are “probationer” and “parolee.” The “reporting” and “checking in” are also used interchangeably. The probationer list application and probationer list are used interchangeably. The appointment calendar application and appointment calendar are used interchangeably. The map application and map are used interchangeably. The calendar application and calendar are used interchangeably.

In an overview, the present invention provides an apparatus that provides a visual display of real time probationer recidivism risk assessment information to a case officer who might be out in the field visiting probationers. The apparatus communicates with a remote server and receives continuous update of probationer information from the server. The apparatus also alerts the case officer about the update probationer information that may impacts the case officer's appointment schedule because of the high risk of recidivism of the probationer who needs to be seen immediately. When the appointment scheduled is changed, the apparatus automatically calculates and suggests an update visiting route that considers the existing appointment and traffic condition.

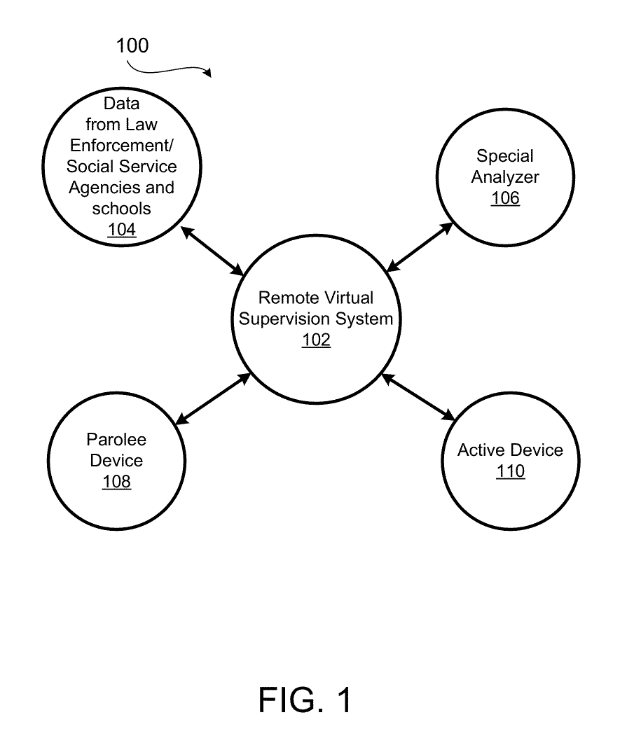

FIG. 1 depicts the relationship 100 between an active device 110 of the present invention and a remote supervision system 102 and other components that supports the remote supervision system 102. The remote supervision system 102 receives data that includes (1) check-in information from probationer devices 108, which is a portable device in the possession of a probationer (and includes any mobile data transmission device such as a smartphone), and the check-in information, which includes audio and video files and the location (GPS) information on the probationer devices 108, (2) additional data from law enforcement and other agencies 104, and (3) information from the case officer's active device 110, and forwards all such data from 104, 110 and 108 to the special analyzer 106 for analysis of recidivism risk assessment.

The likelihood of recidivism can be predicted using the following function:

Recidivism=F (housing, education, job, sobriety/drug use);

where,

housing reflects on P/P's housing condition, who are house mates for the P/P,

job reflects on whether P/P has a steady job, education reflects P/P's attendance in training programs, employable skills, and interest in changing behavior, and

sobriety/drug use reflects whether P/P is suspected of violating sobriety/drug use conditions of release.

The results of the analysis by special analyzer 106 are transmitted back to the remote virtual supervision system 102 for storage and distribution to case officer devices 110. The supervision system 102 then sorts the information among the various case loads of each officer and transmits the analyzed results regarding risk of recidivism of each officer's case load onto that officer's device 110. The active device 110 receives the probationer risk assessment information from the remote virtual supervision system 102 for that device's case load; information received include case information, probationer profile, probationer recidivism risk assessment and a ranking of which probationers in the officer's case load are most likely to recidivate. In addition to calculating the risk of recidivism, the remote supervision system 102 and special analyzer 106 may also analyze the information received to identify and predict the risk of criminal activity by location as well as identify what factors have changed that increase the likelihood of criminal activity in a given location. This information helps local governments and law enforcement to manage and reduce criminal activities overall. Though the special analyzer 106 and the remote virtual supervision system 102 are shown as separate entities, their functionalities may be provided by one single device.

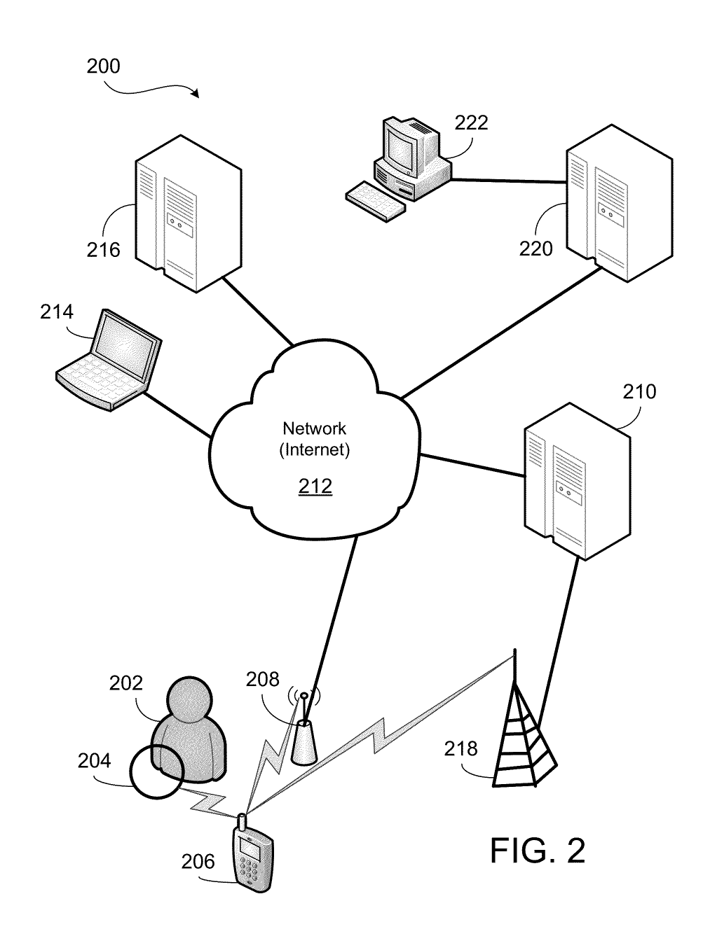

FIG. 2 depicts system architecture of the remote supervision system according to the invention. A probationer 202 may be fitted with a software application enabled on the probationer device 206 that he carries on his body at all times. This software application enables the probationer device 206 to communicate periodically with a cell tower 218, which is connected to a base station (not shown). The base station is connected to a mobile switching center (MSC) 210. The mobile switching center 210 is connected to a data communication network (the Internet) 212. A remote server 220, on which the remote monitoring system 102 is executed, that collects information from the probationer device 206 is also connected to the Internet 212. The information collected can be accessed through a terminal 222 by a case officer or sent to an active device 214 that is with the case officer on the field. The probationer device 206 may also be “pinged” by the cell tower 218 and other nearby cell towers to calculate the location of the probationer device 206 without use of the software application in the event the software is unavailable, inactive or deactivated. This “ping” data is forwarded from the carrier via Internet 212 to the server 220.

The remote supervision server 220 (remote monitoring system 102) will communicate with the case officer who is out on the field visiting probationers 202. The case officer may be carrying the active device 214. The remote supervision server 220 will send to the active device 214 the latest probationer information about the probationers' information and their risk assessment that the case officer is monitoring. The remote supervision server 220 will suggest a prioritized list of which probationers to visit first for the case officer's visiting schedule according to the latest updates about the probationers and their risk of recidivism. The active device 214 may also initiate an information update from the remote supervision server 220.

The case officer also uses his active device 214 to provide updated information about the probationer after the probationer meeting factors relevant to the recidivism risk assessment, such as drug use, dysfunctional living conditions, unemployment, living arrangements, motivations, temperament, sobriety, emotional support, probationer attitude, etc.

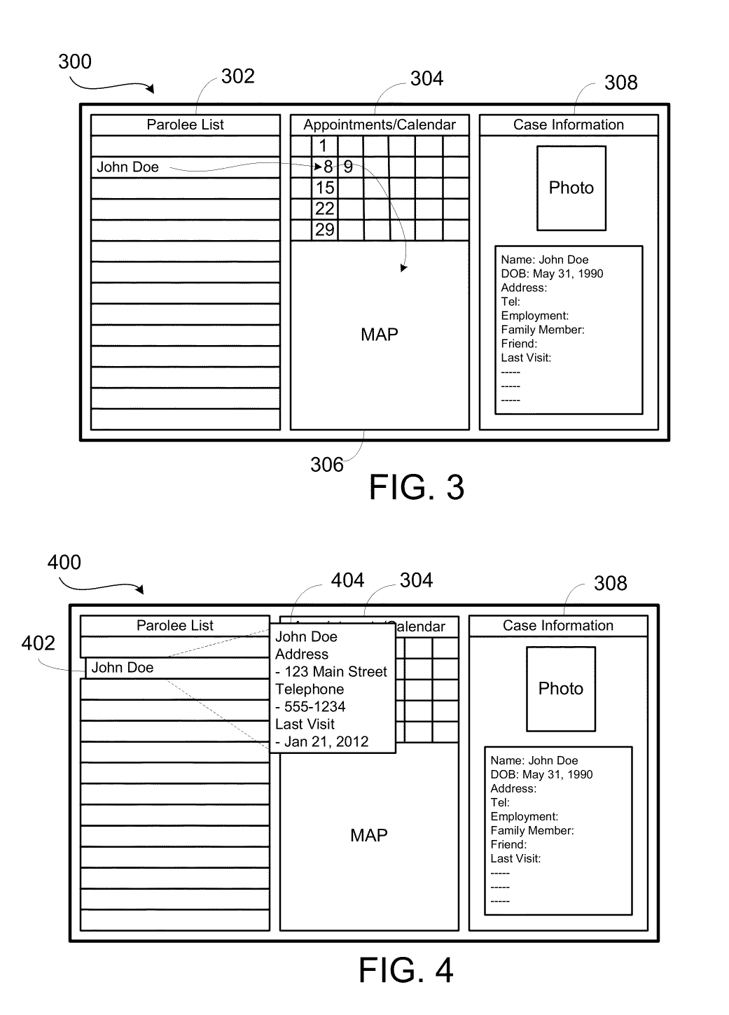

FIG. 3 is an illustration 300 of an active device 214. The active device 214 has several applications: a probationer list application, a case information application, a map application, and an appointment calendar application. Each application is responsible for handling the information that is displayed in a corresponding area on FIG. 3. The active device 214 has a display screen for displaying the information to a case officer. The information may be received from the remote monitoring system 102 or generated by the active device 214 based on the information from the remote supervision server 220. The active device 214 receives the probationer information from the remote supervision server 220 and displays the probationer information on the probationer list 302. The probationer list 302 displays the list of all the probationers assigned to the case officer. The probationer list 302 may list the probationers sequentially depending on each probationer's risk of recidivism, which is based on the information received from the remote monitoring system 102. The order of the probationer list 302 may be altered according to updated probationer information that the active device 214 receives from the remote monitoring system 102. For example, if it is learned that probationer John started to associate with known criminal in his neighborhood, this information will make the case for John more visible to the case worker and making a visit to John more urgent. This means that the priority of John's case is increased and John will be placed in a higher position in the probationer list 302.

When a probationer's case is critical or occupies a higher (priority) position in the probationer list 302, it means that the case officer should visit the probationer sooner before other probationers, and more frequently. The case officer can schedule visits to probationers under his supervision by dragging the name of the probationers from the probationer list 302 and placing the name onto the appointment calendar 304. After the name is dropped on the appointment calendar, a pop up screen will open for the case officer to input additional information, such as the time of the appointment and/or the address of the probationer. The appointment calendar can be displayed in the monthly format or weekly format. Alternatively, an appointment schedule will be automatically calculated by the appointment calendar application. The address of the probationer is preferably taken from the probationer information and pre-filled in the pop-up screen and the case officer can change it. The appointment calendar may be altered manually by the case officer.

After the name of a probationer is placed in the appointment list 304, on the day of his visit his location will be automatically displayed prominently in the map display 306. As the appointment calendar 304 is being populated, the active device 214 will calculate the best route for the case officer. The best route is calculated by taking into consideration the distance between the locations of visits, the appointment time, and other information. Other sources may include the latest traffic conditions received from local authorities. The case officer can change the route by modifying the order (time) of visits. If the order of the visits is altered, the active device 214 will automatically recalculate the route and also the appointment schedule.

The location of a probationer will be displayed less prominently, e.g., displayed in semi-transparent manner or in a different color, before the day of his scheduled visit. When a new visit to another probationer is scheduled for a different day but the location is close to an already scheduled visit, the active device 214 will detect the proximity between two locations and may generate a pop-up window with a suggestion of moving two visits to the same day. The case officer can then decide whether to accept the suggestion of moving two physically close visits into one single day.

The case officer may enter certain default information in the appointment calendar 304. The default information may include the earliest appointment time, the latest appointment time, and the regular appointment duration. This default information is applicable for all visits, but the default information may be modified for any particular day or any particular visit. For example, the case officer may set the earliest appointment time to be 9 AM, the latest appointment time to be 3 PM, and the regular appointment duration to be 1 hour. Using this default information and the list of probationers on the appointment calendar 304, the appointment calendar 304 can calculate automatically a detail appointment schedule with an appointment time for each probationer. The calculation of the appointments is done by taking consideration of the location of each probationer, the traffic condition, and the duration of each visit. Though the appointment calendar 304 generally displays the appointments for the current day, the appointment calendar 304 may display any day that the case officer selects from the calendar. By simple touch on any day in the calendar, automatically the appointments for the selected day will be retrieved from a storage unit and populated on the appointment calendar 304 and the route for the appointments will be displayed on the map display 306.

The case officer can set up appointments for any future date by touching the future date on the appointment calendar 304 and it will then reflect the appointment for that particular date. The case officer can then proceed to make appointments as described above. When selecting a probationer for a visit, the appointment application will automatically check the last appointment for this probationer. If the new appointment is within a predefined period, for example, within a week, the appointment application will display a warning about the closeness of two visits. This checking is for the past appointment and also for the future appointments and this will prevents the case officer from making a new appointment to a probationer for next week if the case officer just made an appointment for the same probationer for tomorrow. The case officer will have the option of overriding the warning and make appointments close in time to the same probationer. The case officer can modify the default time between two visits.

A case information display area 308 will display the probationer's photo, case information, most current biographic detail, and probation action plan progress; changes to this information overtime can be updated to server 220 and supervision system 102 by the case officer after every appointment with a probationer by entering text information or digital photos taken by the device 214. An “action plan” is a list of activities that the probationer must undertake in order to reduce his risk of recidivism. The case officer can monitor a probationer's action plan progress through a progress bar that runs across display 308 showing what action plan objectives have been completed and what objectives remain to be completed. Clicking on any progress bar will display details of the progress including how well each activity was completed.

FIG. 4 displays a screen 400 for scheduling a visit to a probationer. Though the probationer list 302 lists the probationer by the priority assigned, the appointment calendar 304 is populated by the case officer. The probationers with high priority may or may not be selected for a visit. The case officer selects the probationers from the probationer list 302 for visit and the selection using the probationer list 302 as one of the inputs. The case officer may consider other factors as well. For example, a probationer may be selected because his house is in the proximity of other probationers that the case officer already selected. A probationer may also be selected because the case officer learned some information pertinent to this probationer through other channels.

When the case officer selects a probationer, the case officer touches the box 402 with the probationer's name and the box 402 will be highlighted and move slightly to the right. A pop-up window 404 with the probationer's information will pop up. If the case officer realizes that he touches the wrong name, the case officer can just lift his finger and the pop-up window 404 will disappear and the box 402 will move back into the probationer list. If the case officer has selected the right probationer, the case office can then drag the probationer's name and drop it in an appointment slot the appointment calendar 304. The case officer can drop the probationer in a particular place in the appointment calendar 304; the case officer may also alter the position of this probationer on the appointment calendar 304 by dragging and moving the appointment slot to another position in the appointment calendar 304.

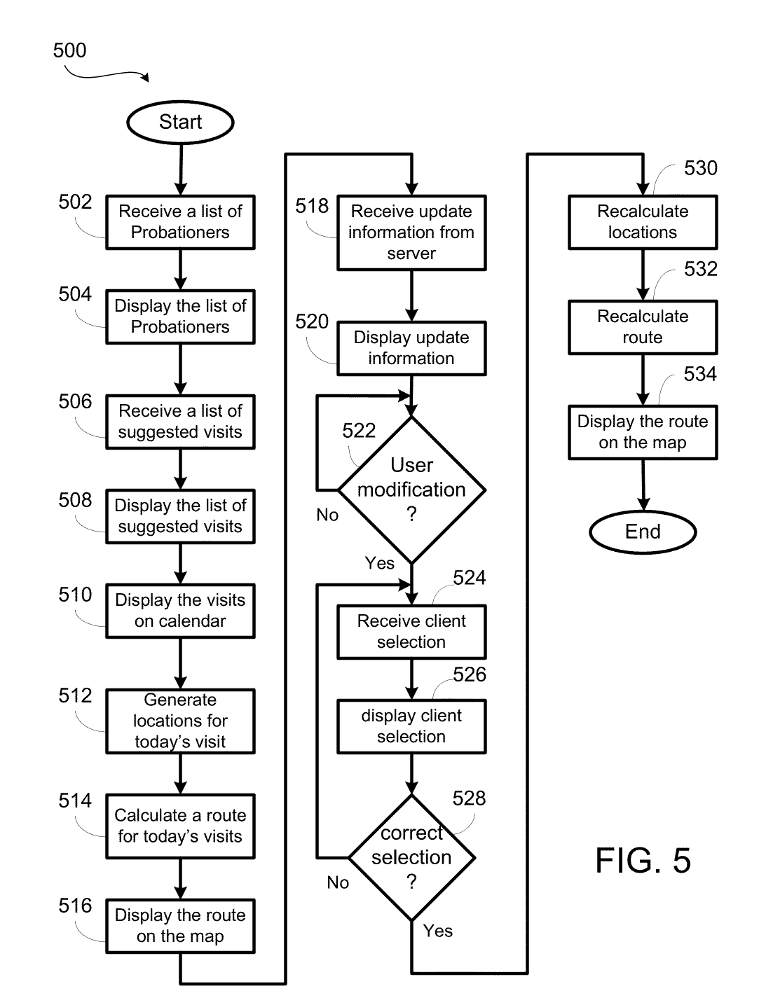

FIG. 5 illustrates a process 500 for planning visits using the real time probationer information according to the invention. The case officer uses an active device 214 to help him to track and plan visits to the probationers. The active device 214 communicates wirelessly with a remote supervision server 220 and receives a list of probationers, step 502, that are assigned to the case officer. The list of the probationers is displayed on the probationer list 302 on the active device 214, step 504, in the order of priority as determined by the remote supervision server 220. Alternatively, the order of priority can also be determined by the active device 214. The active device 214 also receives a list of suggested visits, step 506, from the remote supervision server 220. The list of suggested visits is determined according to an algorithm based on recidivism by the remote supervision server 220. Alternatively, the list of suggested visits may also be generated by the active device 214 using the same algorithm.

The list of suggested visits is displayed on the appointments calendar 304, step 508. The case officer can modify the list of suggested visits by dragging a new name to the list or by dragging a name out of the list. The active device 214 will also populate the calendar display area 304, step 510, and locate the location of each visit on the map display 306, step 512. Besides locating the place of each visit, the active device 214 also calculate a route to cover all the scheduled visits, step 514, and the calculated route is display on the map display 306, step 516. The case officer may alter the sequence of visits, thus the route needs to be recalculated.

The active device 214 may receive updated information from the remote supervision server 220, step 518. The updated information may affect probationer's priority, and the new probationer's list may be displayed, step 520. The user may modify the priority of probationers on the probationer list 302 and may also the appointment list 304. The active device 214 checks whether the case officer makes any modifications, step 522. If the case officer makes a modification, the active device 214 receives the client selection, step 524, and displays the client selection, step 526, to the client for confirmation. The selected name is highlighted and a window 404 pops up with probationer information. If the name is not correct, the case officer can simply lift his hand and the selection is undone, and then the case officer can try to select again by repeating steps 524 and 526. If the selection is correct, the case officer moves the selected probationer into the appointment calendar 304, and the location is calculated, step 530, and route recalculated, step 532. Finally, the updated route is displayed on the map display 306, step 534.

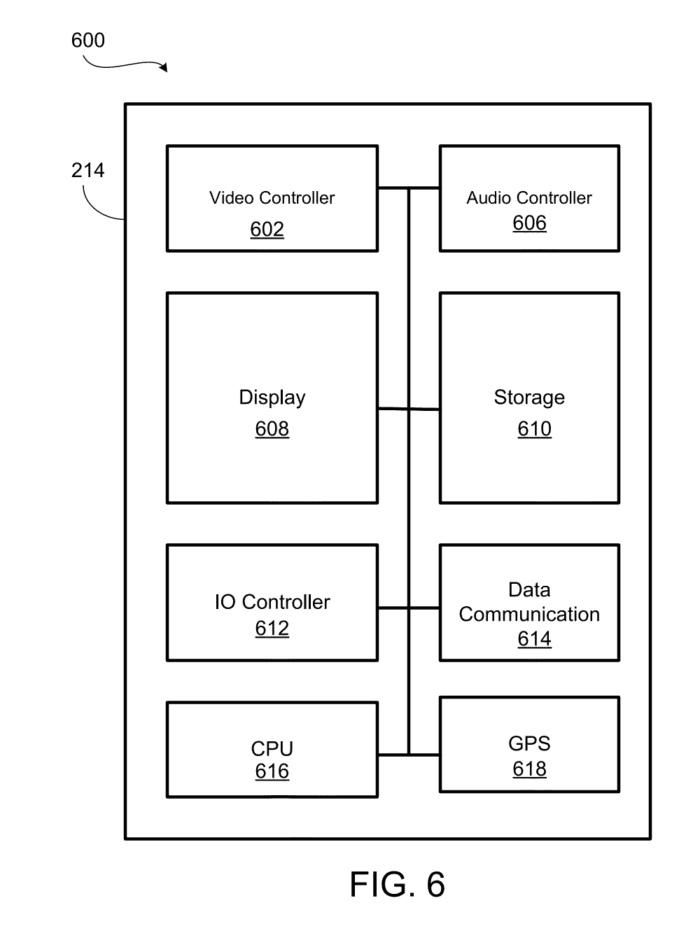

FIG. 6 is a logic block diagram 600 for an active device 214. The active device 214 has a video controller 602 for controlling a video display, an audio controller 606 for controlling audio, a display screen 608 that can be divided to display separate images, such as the probationer list 302 and the appointment calendar 304, an input/output (IO) controller 612 for controlling user interface, a data communication controller 614 for transmitting and receiving data to and from the remote supervision server 220, a global positioning system (GPS) unit 618 for receiving GPS information, a central processing unit (CPU) 616, and a storage unit 610. The video controller 602 controls the display of different information display areas. The audio controller 606 controls the display of audio messages. The display screen 608 displays different information on separate display areas. The IO controller 612 controls data input and output operations. The data communication controller 614 enables the active device 214 to send and receive data to and from probationer information the remote supervision server 220. The storage unit 610 is a non-transitory, computer readable storage device and used for storing instructions, GPS data/time-date data/text/audio/video files, and information received from external sources. The CPU 616 controls the operation of the active device 214 by executing instructions stored in the storage unit 610. The CPU 616 can coordinate smooth probationer data transfer between different applications, such as between the probationer list application, which ranks the probationer according to their priority, and the appointment application, which automatically set up appointment time according to their geographical locations and traffic conditions. It is understood that each logic block in FIG. 6 may be implemented by hardware, software, or combination thereof.

The data communication center 614 can receive the latest probationer “risk-needs” data (recidivism risk) from the remote supervision server 220 and this latest data may affect the ordering of the priority in the probationer information. Alternatively, the CPU 616 may also calculate this recidivism risk using information received by the data controller 614. A probationer, who had a low priority and not scheduled for a visit, may have his priority bumped up because what he did on the night before and he may receive an early visit today.

When in use, the active device 214 of the present invention enables a case officer to manage the visits to probationers 202 assigned to him. For instance, a case officer may be assigned to monitor many probationers and he has to visit these probationers on a regular basis. However, not all the probationers need a close monitoring; for some probationers, because of their crimes or their recent behavior, a less level of monitoring may be enough. All the probationers assigned to the case officer will be listed on the probationer list 302 according to their priority and the case officer can select who to visit according to the priority and also the general geographical area that the case officer will visit on a particular day.

After the case officer selected the probationers he wants to visit and drag-and-drop their names onto the appointment calendar 304, the appointments calendar application will automatically calculate an appointment schedule. The appointment schedule is calculated based on the default earliest appointment time for the case officer (preset by the case officer), the default duration of each visit (preset by the case officer), and the travel time between different locations. The calculated appointment schedule can be overridden by the case officer and the order of visits can also be re-arranged by the case officer. After the appointment schedule is calculated, the active device 214 will display the route for the visits on the map 306.

The active device 214 also allows the case officer to set up future visits. The case officer can simply choose a future date from the appointment calendar 304 and then the appointment calendar 304 will reflect the appointments for that selected date. The case officer can populate the appointment calendar as described above.

The method of the present invention can be performed by a program resident in a computer readable medium, where the program directs a computer device, such as an active device of the present invention, having a computer platform to perform the steps of the method. The computer readable medium can be the memory of the server.

In the context of FIG. 5, the active device 214 may have different components different from those illustrated in FIG. 5 for multiple components may be combined in a single component and the functions executed by one component in FIG. 5 may be executed by two or more components. In the context of FIG. 4, the steps illustrated do not require or imply any particular order of actions. The actions may be executed in sequence or in parallel.

While the invention has been particularly shown and described with reference to a preferred embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated.

What is claimed is:

1. An apparatus, for assisting a probation officer to track and plan visits to probationers according to the risk of recidivism of each probationer, comprising:
a data communication controller for receiving probationer information from a remote server;
a display for displaying information;
a central processing unit for controlling operation of the apparatus; and
a storage unit for storing the probationer information received from the remote server and also for storing applications, which when executed by the central processing unit causes the apparatus to:
display a list of probationers according to a recidivism risk assigned to each probationer on the display;
receive inputs from the probation officer;
populate an appointment calendar according to the inputs received;
determine a location for each appointment on the appointment calendar; and
calculate a path for visiting appointments on the appointment calendar.

2. The apparatus of claim 1, where in the data communication controller further being capable of sending update information to the remote server.

3. The apparatus of claim 1, further comprising a global positioning system (GPS) unit for receiving GPS information and the central processing unit further causes the apparatus to calculate a path for visiting the appointments on the appointment calendar using the GPS information.

4. The apparatus of claim 1, where in the central processing unit further causes the apparatus to calculate the recidivism risk for each probationer.

5. The apparatus of claim 1, where in the probationer information from a remote server received by the data communication controller further comprises the recidivism risk for each probationer.

6. The apparatus of claim 1, wherein the applications further comprising:
a probationer application; and
an appointment calendar application.

7. The apparatus of claim 1, where in the central processing unit further causes the apparatus to detect proximity of two appointments on different dates and to display a suggestion of moving the two appointments into one single day.

8. A method, for assisting a probation officer to schedule visits to probationers, comprising the steps of:
receiving probationer information for a plurality of probationers from a remote server, the probationer information for each probationer including a recidivism risk;
displaying a list of probationers according to the recidivism risk assigned to each probationer on a display device;
receiving inputs from the probation officer;
populating an appointment calendar according to the inputs received;
determining a location for each appointment on the appointment calendar; and
calculating a path for visiting appointments on the appointment calendar.

9. The method of claim 8, further comprising the steps of:
receiving a GPS information; and
calculating a path for visiting the appointments on the appointment calendar using the GPS information.

10. The method of claim 8, further comprising the step of calculating the recidivism risk for each probationer.

11. The method of claim 8, further comprising the steps of:
detecting proximity of two appointments on different dates; and
displaying a suggestion of moving the two appointments into one single day.

12. The method of claim 8, further comprising the step of sending update information to the remote server.

13. A tangible non-transitory computer-readable medium comprising instructions that, when executed by a processor, cause the processor to perform acts, for assisting a probation officer to schedule visits to probationers, comprising:
receiving probationer information for a plurality of probationers from a remote server, the probationer information for each probationer including a recidivism risk;
displaying a list of probationers according to the recidivism risk assigned to each probationer on a display device;
receiving inputs from the probation officer;
populating an appointment calendar according to the inputs received;
determining a location for each appointment on the appointment calendar; and
calculating a path for visiting appointments on the appointment calendar.

14. The tangible non-transitory computer-readable medium of claim 13, wherein the instructions, when executed by the processor, further cause the processor to perform acts comprising:
receiving a GPS information; and
calculating a path for visiting the appointments on the appointment calendar using the GPS information.

15. The tangible non-transitory computer-readable medium of claim 13, wherein the instructions, when executed by the processor, further cause the processor to perform acts comprising calculating the recidivism risk for each probationer.

16. The tangible non-transitory computer-readable medium of claim 13, wherein the instructions, when executed by the processor, further cause the processor to perform acts comprising:
detecting proximity of two appointments on different dates; and
displaying a suggestion of moving the two appointments into one single day.

17. The tangible non-transitory computer-readable medium of claim 13, wherein the instructions, when executed by the processor, further cause the processor to perform acts comprising sending update information to the remote server.
